(19) United States
(12) Patent Application Publication
(10) Pub. No.: US 2026/0348569 A1
(43) Pub. Date: Nov. 5, 2026

(54) Light fixture with light head locked by deformable locking assembly

(71) Applicant: Guangzhou Haoyang Electronic Co., Ltd., Guangzhou (CN)

(72) Inventors: Weikai JIANG, Guangzhou (CN); Jun LUO, Guangzhou (CN); Zhiqiang CHEN, Guangzhou (CN)

(21) Appl. No.: 19/315,009

(22) Filed: Aug. 29, 2025

(30) Foreign Application Priority Data
Apr. 30, 2025 (CN) 202510575131.0

(51) Int. Cl. F21V 21/30

(52) U.S. Cl. CPC F21V 21/30

(57) ABSTRACT

A light fixture includes a light head for emitting light beams; a supporting seat for supporting rotation of the light head, the light head being pivotally connected to the supporting seat through a pivot shaft and a shaft sleeve, with the shaft sleeve mounted outside the pivot shaft; and a deformable locking assembly, including a deformable member and an operating member, wherein the operating member is configured to apply a force on the deformable member in a length direction of the pivot shaft, and deform the deformable member in a direction perpendicular to the length of the pivot shaft, with a pressing part of the deformable member pressed against the shaft sleeve or the pivot shaft, to restrict relative rotation between the shaft sleeve and the pivot shaft.

### CROSS REFERENCE TO RELATED APPLICATIONS

The present application claims priority from Chinese Application No. CN 202510575131.0 filed on Apr. 30, 2025, all of which are hereby incorporated herein by reference.

### TECHNICAL FIELD

The present disclosure relates to the technical field of light fixtures, and more specifically, to a light fixture with a light head locked by a deformable locking assembly.

### BACKGROUND

A light fixture generally includes a light head for emitting light beams and a supporting seat for supporting rotation of the light head. Usually, the rotation angle of the light head relative to the supporting seat can be adjusted manually or adjusted electrically by a motor, and the light head is often fixed at a specific angle for performance use. In the case that the light head is continuously hold at the specific angle by the motor, a large amount of electricity is required. Accordingly, the light head is typically locked or fixed by a locking assembly. In order to achieve different specific angles for different performances, the light head is generally selectively fixed at a plurality of specific angles by a lock tongue selectively cooperating with a plurality of locking positions on a lock disc in the existing technology. However, in such way the light head cannot be fixed at any arbitrary angle, which thus cannot achieve stepless locking, i.e. locking position of the light head cannot be continuously adjusted.

### SUMMARY

The present disclosure therefore provides a light fixture with a light head locked by a deformable locking assembly, in which a deformable member is provided to act on a pivot shaft or shaft sleeve to restrict relative rotation therebetween, thereby achieving stepless locking.

The light fixture of the present disclosure includes a light head for emitting light beams; a supporting seat for supporting rotation of the light head, where the light head is pivotally connected to the supporting seat through a pivot shaft and a shaft sleeve, with the shaft sleeve mounted outside the pivot shaft; and a deformable locking assembly, including a deformable member and an operating member, where the operating member is configured to apply a force on the deformable member in a length direction of the pivot shaft, and deform the deformable member in a direction perpendicular to the length of the pivot shaft, with a pressing part of the deformable member pressed against the shaft sleeve or the pivot shaft, to restrict relative rotation between the shaft sleeve and the pivot shaft.

In the light fixture of the present disclosure, through the operating member a force may be exerted on the deformable member in the length direction of the pivot shaft, when the light head is located at any angle relative to the supporting seat, which deforms the deformable member in the direction perpendicular to the length of the pivot shaft, with the pressing part of the deformable member pressed against the shaft sleeve or the pivot shaft to restrict relative rotation therebetween, thereby achieving stepless locking of the light head. In this way, the force in the length direction of the pivot shaft is converted into an acting force perpendicular to the length direction of the pivot shaft through deformation of the deformable member, and finally applied to the shaft sleeve or the pivot shaft. This enables stepless locking through rotation limitation on the light head directly via the existing pivot shaft and shaft sleeve, with minimum modification to the existing structure of the light fixture.

According to a preferable embodiment of the present disclosure, in order to bear a greater external force and thus obtain improved durability, the deformable member in the present disclosure may include a rigid connecting plate and a rigid inclined plate that are connected to each other, and the operating member may be configured to apply the force on the deformable member to change an included angle between the inclined plate and the connecting plate and drive the pressing part to move. In such configuration, the connecting plate and the inclined plate are both rigid, and the deformable member is deformed by changing the included angle between the inclined plate and the connecting plate, rather than relying on an elastic material. Therefore, the deformable member in the present disclosure can bear a greater external force and achieve improved durability.

As larger included angle between the inclined plate and the direction of the pivot shaft can significantly amplify and transfer the force from the operating member to the shaft sleeve or the pivot shaft, the pressing part may be formed by an end portion of the inclined plate away from the connecting plate, and the operating member is configured to apply the force on the connecting plate to drive the pressing part to move in the direction perpendicular to the length of the pivot shaft. This allows the included angle between the inclined plate and the connecting plate to remain relatively large and thus avoids metal fatigue caused by excessive bending.

According to the present disclosure, the operating member may be in a form of a pull rod extending in the length direction of the pivot shaft. In such easy way, the included angle between the inclined plate and the connecting plate can be changed with movement of the pull rod along the length direction of the pivot shaft.

Furthermore, the pull rod may be in threaded connection with a nut and provided with a pressing protrusion, and the pressing protrusion and the nut may be configured to press the deformable member to deform under rotation of the pull rod relative to the nut. Through the nut, the rotation of the pull rod relative to the nut can be converted into movement in the length direction of the pivot shaft, which facilitates force application and can increase force torque. Therefore, the pull rod in the present disclosure can move in the length direction of the pivot shaft through a smaller torque.

Additionally, an additional seat having a through hole may be further provided, the pressing protrusion is penetrated through the through hole and pressed against one side of the deformable member, and the nut is pressed against the other side of the deformable member, so that the deformable member is hold between the nut and the pressing protrusion and deformed under the force applied by the nut or the pressing protrusion.

In a preferable embodiment of the present disclosure, a limiting column may be further provided to restrict the included angle between the connecting plate and the inclined plate in a predetermined range. Specifically, the length of the limiting column can be designed as required in a way that when the connecting plate approaches, the limiting column is pressed against the connecting plate to limit further movement of the connecting plate.

In an advantageous embodiment of the present disclosure, in a bid to further increase force bearing capacity, two deformable members may be arranged opposite to each other, and the connecting plates of two deformable members may be each circumferentially connected with at least two inclined plates, with the connecting plates of the two deformable members face away from each other and end portions of the inclined plates of the two deformable members correspondingly pressed against each other. As the at least two inclined plates can share stress, stronger force bearing capacity can be achieved. In addition, fracture due to metal fatigue at the connection between the single inclined plate and the connecting plate can be avoided.

Furthermore, the end portions, pressed against each other, of the inclined plates of the two deformable members may be jointly mounted in a fixing frame. The fixing frame integrates the end portions, abutted against each other, of the two inclined plates into a single piece, allowing them to move together, thereby avoiding separation.

In order to increase friction between the pressing part and the shaft sleeve or the pivot shaft, the pressing part in the present disclosure may be provided with a friction plate.

The shaft sleeve may be connected to the light head and the pivot shaft may be connected to the supporting seat. That is, the shaft sleeve can rotate with the light head, while the pivot shaft remains stationary with the supporting seat.

In this case, the deformable member and the operating member may be mounted in the pivot shaft. In the rotation of the light head, the deformable member and the operating member remain stationary along with the supporting seat and do not rotate if not operated, enabling better user experience.

In addition, the pivot shaft may be provided with an accommodating cavity for accommodating the deformable member, which makes the deformable member not exposed; and a cavity wall of the accommodating cavity is provided with a hollow hole, through which the pressing part is smoothly penetrated to be pressed against the shaft sleeve.

In the present disclosure, a bottom of the accommodating cavity may be provided with an avoidance hole corresponding to the operating member to provide a larger space for the movement of the operating member, which can minimize the protruding extent of the operating member from the pivot shaft.

An additional seat may be further detachably connected to the pivot shaft, and the accommodating cavity may be formed in the additional seat. The additional seat allows for installation and accommodation of the deformable member without major modifications to the original or exist pivot shaft.

Additionally, the additional seat in the present disclosure may be formed with an expansion part, especially at the middle portion of the outside of the additional seat in the length direction of the pivot shaft, the hollow hole may be formed in the expansion part, and a bearing may be mounted at each end of the expansion part, with an inner ring of the bearing pressed against the expansion part and an outer ring of the bearing pressed against the shaft sleeve or a pressing plate connected to the shaft sleeve. The expansion part can support the inner ring of the bearing and also provide a larger space, allowing for larger deformable members to be used, which in turn generates a greater torque and amplifies the acting force from the operating member.

### BRIEF DESCRIPTION OF THE DRAWINGS

FIG. 1 is perspective view of a light fixture according to the present disclosure;

FIG. 2 is a cross-sectional view of FIG. 1;

FIG. 3 is a partially enlarged view of portion A in FIG. 2;

FIG. 4 is a disassembly view of a deformable locking assembly, a pivot shaft, and a shaft sleeve according to an embodiment of the present disclosure; and

FIG. 5 is an assembly view of FIG. 4.

Reference signs: 110 light head; 120 supporting seat; 121 base; 122 support arm; 200 pivot shaft; 210 additional seat; 211 accommodating cavity; 212 hollow hole; 213 through hole; 214 avoidance hole; 215 expansion part; 220 bearing; 221 pressing plate; 300 shaft sleeve; 400 operating member; 410 pressing protrusion; 420 nut; 430 knob; 500 deformable member; 510 connecting plate; 520 inclined plate; 521 pressing part; 530 bent sheet; 540 limiting column; 550 fixing frame; 551 open end; 552 accommodating groove; 560 friction plate.

### DETAILED DESCRIPTION OF THE EMBODIMENTS

Accompanying drawings are for illustrative purposes only and should not be construed as limiting this patent. To better illustrate the embodiments, some components in the accompanying drawings are omitted, enlarged or reduced in scale, which does not represent dimensions of actual products. It may be understood to a person skilled in the art that some well-known structures in the accompanying drawings and descriptions thereof may be omitted. Positional relationships described in the accompanying drawing are for illustrative purposes only and should not be construed as limiting this patent.

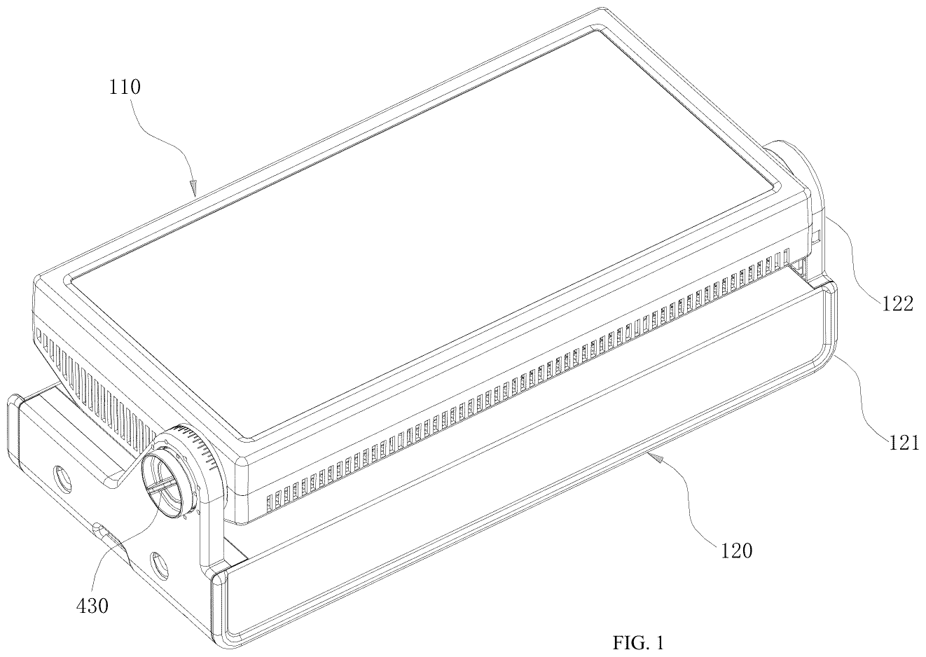

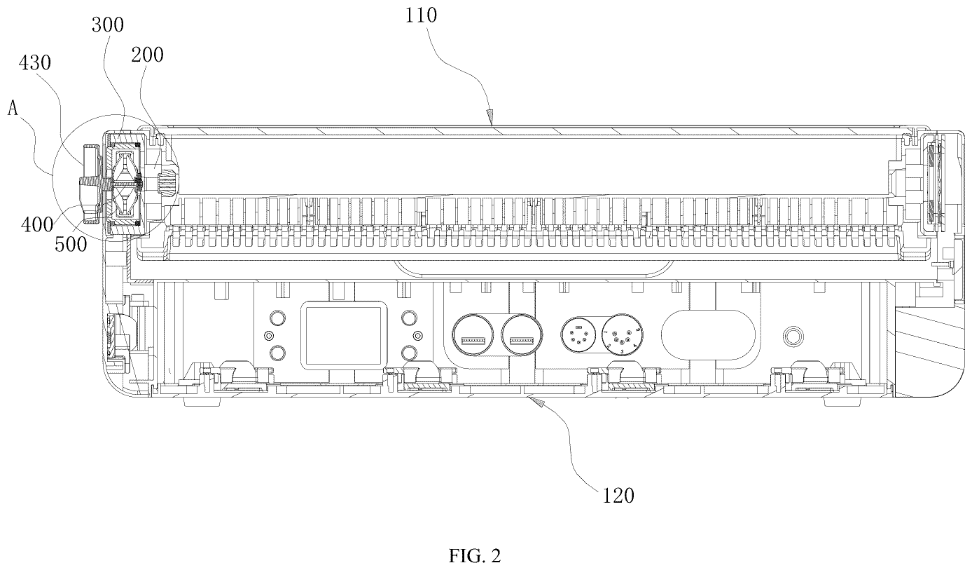

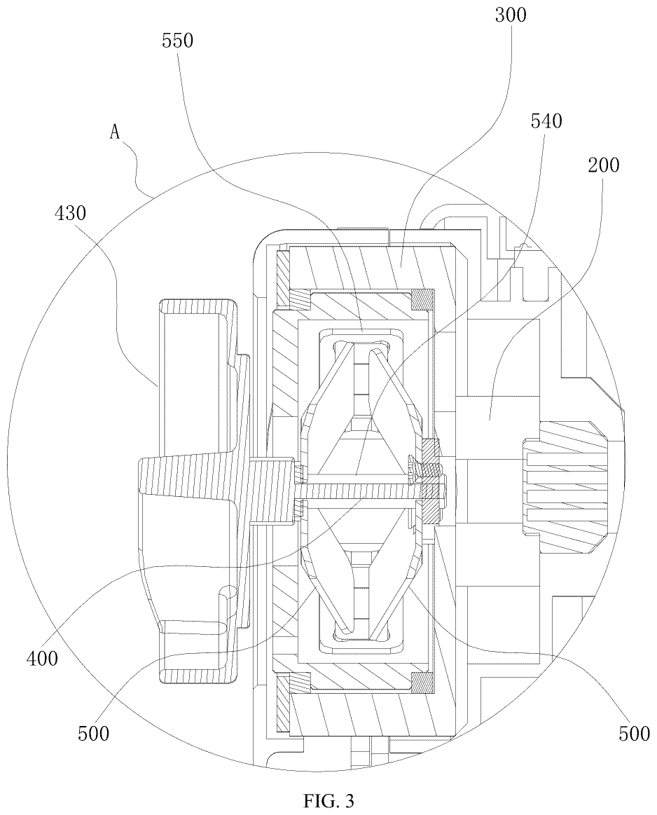

FIG. 1 and FIG. 2 provides a light fixture a light head locked by a deformable locking assembly according to an embodiment of the disclosure, which includes a light head 110 for emitting light beams and a supporting seat 120 for supporting rotation of the light head 110. In further combination with FIG. 3, the light head 110 is pivotally connected to the supporting seat 120 through a pivot shaft 200 and a shaft sleeve 300, with the shaft sleeve 300 being mounted outside the pivot shaft 200. The deformable locking assembly has a deformable member 500 and an operating member 400. The operating member 400 can apply force on the deformable member 500 in a length direction of the pivot shaft 200 to deform the deformable member 500 in a direction perpendicular to the length of the pivot shaft 200. When the deformable member 500 is in deformation, a pressing part 521 of the deformable member 500 is pressed against the shaft sleeve 300 or the pivot shaft 200 to restrict relative rotation between the shaft sleeve 300 and the pivot shaft 200.

In the light fixture of the present embodiment, through the operating member 400 a force may be exerted on the deformable member 500 in the length direction of the pivot shaft 200, when the light head 110 is located at any angle relative to the supporting seat 120, so that the deformable member 500 is deformed in the direction perpendicular to the length of the pivot shaft 200, with the pressing part 521 pressed against the shaft sleeve 300 or the pivot shaft 200 to restrict relative rotation therebetween, thereby achieving stepless locking of the light head 110. In such configuration, through deformation the force in the length direction of the pivot shaft 200 is converted into an acting force perpendicular to the length direction of the pivot shaft 200 by the deformable member 500, and finally applied to the shaft sleeve 300 or the pivot shaft 200. This can minimize modification to an existing structure of the light fixture and enables stepless locking, with rotation limitation on the light head 110 directly through the existing pivot shaft 200 and shaft sleeve 300.

As shown in FIG. 1 and FIG. 2, the supporting seat 120 in this embodiment includes a base 121 and a support arm 122 fixedly connected to the base 121, and the light head 110 is pivotally connected to the support arm 122. It should be conceivable that, in other embodiments, the support arm 122 may be pivotally connected to the base 121, i.e. the support arm 122 can also rotate relative to the base 121.

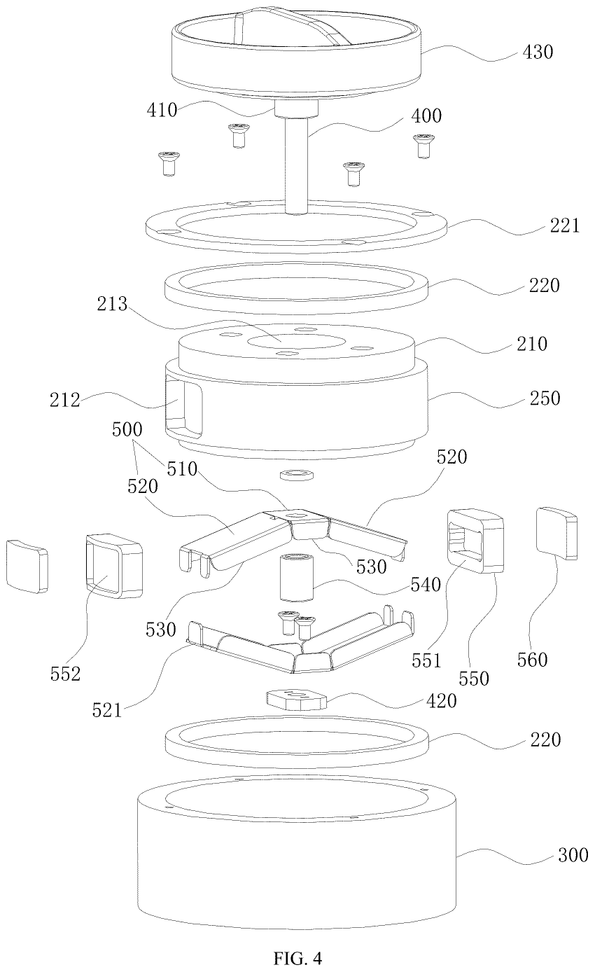

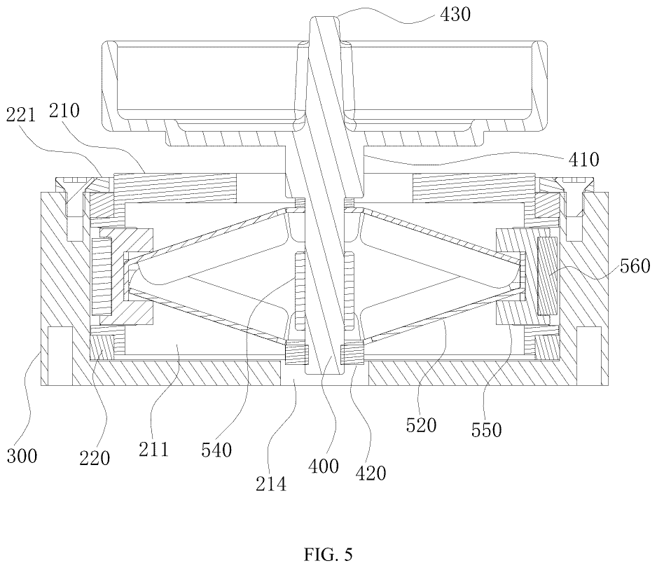

Referring to FIG. 4 and FIG. 5, the deformable member 500 in this embodiment particularly includes a rigid connecting plate 510 and a rigid inclined plate 520 that are connected to each other. The force from the operating member 400 exerted on the deformable member 500 can change the included angle between the inclined plate 520 and the connecting plate 510, so as to cause the pressing part 521 of the deformable member 500 to move in the direction perpendicular to the length of the pivot shaft 200. In this embodiment, the connecting plate 510 and the inclined plate 520 are both in rigid form, and the deformable member 500 is deformed by changing the included angle between the inclined plate 520 and the connecting plate 510, rather than relying on an elastic material, as a result, the deformable member 500 can bear greater external force and has better durability.

In an embodiment, the deformable member 500 may be deformed in a way that an end portion of the inclined plate 520 away from the connecting plate 510 is pressed against the shaft sleeve 300 or the pivot shaft 200, i.e. in this case the end portion of the inclined plate 520 away from the connecting plate 510 serves as the pressing part 521. In an alternative embodiment, the deformable member 500 may be deformed in a way that the connecting plate 510 is pressed against the shaft sleeve 300 or the pivot shaft 200, i.e. in this case the connecting plate 510 serves as the pressing part 521, namely the operating member 400 acts on the inclined plate 520.

Preferably, the connecting plate 510 and the inclined plate 520 are both formed with bending parts 530 to enhance mechanical strength.

In this embodiment, in order to ensure that the included angle between the inclined plate 520 and the direction of the pivot shaft 200 is as large as possible, and the force from the operating member 400 can be significantly amplified and transferred to the shaft sleeve 300 or the pivot shaft 200, the end portion of the inclined plate 520 away from the connecting plate 510 serves as the pressing part 521. In this case, the operating member 400 exert force on the connecting plate 510 to drive the pressing part 521 to move in the direction perpendicular to the length of the pivot shaft 200. This allows the included angle between the inclined plate 520 and the connecting plate 510 to remain in a relatively large range, and thus avoid metal fatigue caused by excessive bending.

Preferably, the included angle between the inclined plate 520 and the connecting plate 510 is greater than 120°, more preferably greater than 150°.

In this embodiment, the operating member 400 is in form of a pull rod extending along the length direction of the pivot shaft 200. The pull rod in this embodiment can move in the length direction of the pivot shaft 200 to change the included angle between the inclined plate 520 and the connecting plate 510.

Particularly, the pull rod is threadedly connected with a nut 420 in a way that the pull rod can rotate relative to the nut 420 to cause a pressing protrusion 410 of the pull rod or the nut 420 to press the deformable member 500 to produce deformation. In this way, movement of the pull rod in the length direction of the pivot shaft 200 is achieved by the rotation of the pull rod relative to the nut 420, which is easy to apply force on the pull rod and can increase force torque, allowing the pull rod to move in the length direction of the pivot shaft 200 through a smaller torque.

Preferably, in order to rotate the pull rod easily, an end of the pull rod away from the nut 420 is connected with a knob 430.

The threaded connection portion of the pull rod with the nut 420 preferably has a diameter less than 1.5 cm, more preferably less than 1 cm, which can increase distance between the pull rod and the pressing part 521, thereby increasing the torque and amplifying the force as much as possible.

It should be noted that, to cause significant movement of the pull rod in the length direction of the pivot shaft 200 due to rotation of the pull rod, the pitch of the thread of the pull rod is designed relatively smaller. This makes the pull rod easier to rotate.

An additional seat 210 is further provided in the present embodiment. The additional seat 210 has a through hole 213 for the pull rod to penetrate through, passing through which the pressing protrusion 410 is pressed against one side of the deformable member 500, and the nut 420 is pressed against the other side of the deformable member 500, allowing the deformable member 500 to hold between the nut 420 and the pressing protrusion 410 and deform under force.

A limiting column 540 is further provided to restrict the included angle between the connecting plate 510 and the inclined plate 520 from exceeding a predetermined range. The length of the limiting column 540 can be designed as required in a way that when the connecting plate 510 approaches, the limiting column 540 is pressed against the connecting plate 510 to limit its further movement.

The limiting column 540 preferably has a length greater than 0.5 cm.

In this embodiment, the pull rod is penetrated through the limiting column 540 in a length direction of the limiting column and then connected to the nut 420.

In a preferred embodiment of the present disclosure, at least two inclined plates 520 are circumferentially connected to the connecting plate 510, and two deformable members 500 are arranged opposite to each other, with the connecting plates 510 of the two deformable members 500 facing away from each other, and end portions of the inclined plates 520 of the two deformable members 500 are correspondingly pressed against each other. With stress sharing of the at least two inclined plates 520, force bearing capacity of the deformable members 500 can be improved, which can also avoid cracking due to metal fatigue at a connection between a single inclined plate 520 and the connecting plate 510.

The limiting column 540 is particularly arranged between the connecting plates 510 of the two deformable members 500 opposite to each other. In the case that the operating member 400 is the pull rod extending in the length direction of the pivot shaft 200, the pull rod is penetrated through the limiting column 540 and the two connecting plates 510 and is then in threaded connection with the nut 420. In this case, the limiting column 540 preferably has a length greater than 1 cm.

More preferably, four inclined plates 520 are evenly circumferentially connected to each connecting plate 510.

The respective end portions, pressed against each other, of the inclined plates 520 of the two deformable members 500 are jointly mounted in a fixing frame 550. The fixing frame 550 integrates the respective end portions, pressed against each other, of the inclined plates 520 into a single piece, allowing them to move together, thereby avoiding separation during abutting.

In one embodiment, the deformable member 500 may be pressed against the shaft sleeve 300 or the pivot shaft 200 through the fixing frame 550. In an alternative embodiment, the deformable member 500 may be pressed against the shaft sleeve 300 or the pivot shaft 200 through the connecting plate 510.

Particularly, the fixing frame 550 is in a cylindrical form, with one end sealed and the other end open. The open end 551 accommodates the end portions, pressed against each other, of the inclined plates 520.

A friction plate 560 is further provided in this embodiment, which can increase friction between the pressing part 521 and the shaft sleeve 300 or the pivot shaft 200.

The friction plate 560 in this embodiment is arranged on a side of the fixing frame 550 away from the deformable member 500, and the fixing frame 550 is provided with an accommodating groove 552 corresponding to the friction plate 560.

In this embodiment, the shaft sleeve 300 is connected to the light head 110 and the pivot shaft 200 is connected to the supporting seat 120. That is, the shaft sleeve 300 rotates with the light head 110, while the pivot shaft 200 remains stationary with the supporting seat 120.

It should be conceivable that, in other embodiments, the shaft sleeve 300 may be connected to the supporting seat 120 and the pivot shaft 200 may be connected to the light head 110.

In this embodiment, the deformable member 500 and the operating member 400 are mounted in the pivot shaft 200. During rotation of the light head 110, the deformable member 500 and the operating member 400 remain stationary with the supporting seat 120 and do not rotate if the operating member 400 is not operated, which enables better user experience.

In this embodiment, the nut 420 in threaded connected with the pull rod is fixed to the pivot shaft 200.

It should be conceivable that, in other embodiments, the deformable member 500 and the operating member 400 may also be mounted on the shaft sleeve 300.

In particular, the pivot shaft 200 is provided with an accommodating cavity 211 for accommodating the deformable member 500, and a cavity wall of the accommodating cavity 211 is provided with a hollow hole 212 for the pressing part 521 to extend through. The accommodating cavity 211 allows the deformable member 500 to hidden inside, and the hollow hole 212 ensures that the pressing part 521 of the deformable member 500 can extend out smoothly to press against the shaft sleeve 300 for engagement.

As shown in FIG. 5, the bottom of the accommodating cavity 211 is provided with an avoidance hole 214 corresponding to the operating member 400. The avoidance hole 214 provides a larger space for the movement of the operating member 400, which minimizes the protruding extent of the operating member from the pivot shaft 200.

Furthermore, the additional seat 210 is detachably connected to the pivot shaft 200, and the accommodating cavity 211 is located in the additional seat 210. The additional seat 210 allows for installation and accommodation of the deformable member 500 without major modifications to the original or existing pivot shaft 200.

In this embodiment, one end, connected to the pivot shaft 200, of the additional seat 210 is open, through which the deformable member 500 enters the accommodating cavity 211. The other end of the additional seat 210 is sealed only with a through hole 213 for the pull rod to extend through.

A middle portion of the additional seat 210 is provided with an expansion part 215 in the length direction of the pivot shaft 200, the hollow hole 212 is located in the expansion part 215, a bearing 220 is mounted at each end of the expansion part 215, with the inner ring of the bearing 220 pressed against the expansion part 215, and the outer ring of the bearing 220 pressed against the shaft sleeve 300 or a pressing plate 221 connected to the shaft sleeve 300. The expansion part 215 can support the inner ring of the bearing 220, and also provide a larger space, allowing for larger deformable members to be used, which in turn generates a greater torque and thus amplifies the force from the operating member 400.

In the present disclosure, the pull rod is in thread connection with the nut 420 and the knob 430 is connected to the end of the pull rod away from the nut 420. In addition, the threaded connection portion of the pull rod with the nut 420 has a diameter less than 1.5 cm. To cause significant movement in the length direction of the pivot shaft 200 due to rotation of the pull rod, smaller pitch of the thread of the pull rod is designed. Furthermore, the included angle between the inclined plate 520 and the connecting plate 510 is greater than 120°. The end portion of the inclined plate 520 away from the connecting plate 510 serves as the pressing part 521, and the operating member 400 acts on the connecting plate 510, causing the pressing part 521 to move in the direction perpendicular to the length of the pivot shaft 200. In this way, the operating member 400 and the deformable member 500 can progressively amplify the force applied by a user to the knob 430 to the greatest extent at each step, which finally acts on the shaft sleeve 300 or the pivot shaft 200. This allows the light head 110 to be locked at any angle without using any external tool and thus achieved stepless adjustment.

Obviously, the foregoing embodiments of the present disclosure are only examples for clearly explaining the present disclosure, and are not intended to limit the implementations of the present disclosure. For a person of ordinary skill in the art, various modifications or variations in different forms may be further made based on the foregoing description. It is not necessary and impossible to exhaust all the implementations herein. Any modifications, equivalent substitutions, or improvements made within the spirit and principle of the present disclosure should fall within the protection scope of the claims of the present disclosure.

What is claimed is:

1. A light fixture, comprising:
a light head for emitting light beams;
a supporting seat for supporting rotation of the light head, wherein the light head is pivotally connected to the supporting seat through a pivot shaft and a shaft sleeve, with the shaft sleeve mounted outside the pivot shaft; and
a deformable locking assembly, comprising a deformable member and an operating member, wherein the operating member is configured to apply a force on the deformable member in a length direction of the pivot shaft, and deform the deformable member in a direction perpendicular to the length of the pivot shaft, with a pressing part of the deformable member pressed against the shaft sleeve or the pivot shaft, to restrict relative rotation between the shaft sleeve and the pivot shaft.

2. The light fixture according to claim 1, wherein the deformable member comprises a rigid connecting plate and a rigid inclined plate that are connected to each other, and the operating member is configured to apply the force on the deformable member to change an included angle between the inclined plate and the connecting plate and drive the pressing part to move.

3. The light fixture according to claim 2, wherein the pressing part is formed by an end portion of the inclined plate away from the connecting plate, and the operating member is configured to apply the force on the connecting plate to drive the pressing part to move in the direction perpendicular to the length of the pivot shaft.

4. The light fixture according to claim 2, wherein the operating member is in a form of a pull rod extending in the length direction of the pivot shaft.

5. The light fixture according to claim 4, wherein the pull rod is in threaded connection with a nut and provided with a pressing protrusion, and the pressing protrusion and the nut are configured to press the deformable member to deform under rotation of the pull rod relative to the nut.

6. The light fixture according to claim 5, wherein an additional seat having a through hole is further provided, the pressing protrusion is penetrated through the through hole and pressed against one side of the deformable member, and the nut is pressed against the other side of the deformable member, so that the deformable member is hold between the nut and the pressing protrusion and deformed under the force applied by the nut or the pressing protrusion.

7. The light fixture according to claim 2, a limiting column is further provided to restrict the included angle between the connecting plate and the inclined plate in a predetermined range.

8. The light fixture according to claim 2, wherein two deformable members are arranged opposite to each other, and the connecting plates of two deformable members are each circumferentially connected with at least two inclined plates, with the connecting plates of the two deformable members face away from each other and end portions of the inclined plates of the two deformable members correspondingly pressed against each other.

9. The light fixture according to claim 8, wherein the end portions, pressed against each other, of the inclined plates of the two deformable members are jointly mounted in a fixing frame.

10. The light fixture according to claim 1, wherein the pressing part is provided with a friction plate.

11. The light fixture according to claim 1, wherein the shaft sleeve is connected to the light head, and the pivot shaft is connected to the supporting seat.

12. The light fixture according to claim 11, wherein the deformable member and the operating member are mounted in the pivot shaft.

13. The light fixture according to claim 12, wherein the pivot shaft is provided with an accommodating cavity for accommodating the deformable member, and a cavity wall of the accommodating cavity is provided with a hollow hole, through which the pressing part is penetrated.

14. The light fixture according to claim 13, wherein a bottom of the accommodating cavity is provided with an avoidance hole corresponding to the operating member.

15. The light fixture according to claim 13, wherein an additional seat is detachably connected to the pivot shaft, and the accommodating cavity is formed in the additional seat.

16. The light fixture according to claim 15, wherein the additional seat is formed with an expansion part, the hollow hole is formed in the expansion part, and a bearing is mounted at each end of the expansion part, with an inner ring of the bearing pressed against the expansion part and an outer ring of the bearing pressed against the shaft sleeve or a pressing plate connected to the shaft sleeve.
